(19) United States
(12) Patent Application Publication
(10) Pub. No.: US 2004/0118855 A1
(43) Pub. Date: Jun. 24, 2004

(54) Tank for fluid under pressure comprising two compartments and manufacturing method for said tank

(75) Inventor: Max Calabro, Villennes (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: EADS LAUNCH VEHICLES, Paris (FR)

(21) Appl. No.: 10/445,913

(22) Filed: May 28, 2003

(30) Foreign Application Priority Data
Jun. 3, 2002 (FR) 0206779

(51) Int. Cl. F17C 1/00

(52) U.S. Cl. 220/560.08

(57) ABSTRACT

The invention concerns a method for manufacturing a tank (1) for fluids under pressure comprising two compartments (8, 10). According to the invention, the method comprises the following steps:

assembling a winding mandrel;

placing a metal wall (4) on the mandrel, said wall (4) being in a folded shape;

forming the external wall (2) by winding around an assembly comprising the mandrel and the folded wall (4);

polymerising the wall (2) and dismantling the mandrel;

unfolding the metal wall (2), in such a way as to obtain a first compartment (8) within the interior of the metal wall (4), and a second compartment (10) between the two walls (2, 4).

The invention also applies to a tank (1) such as that obtained by the method described here above.

Application in the field of launch vehicles and rockets.

### TECHNICAL FIELD

The present invention concerns a tank for fluids under pressure comprising two compartments, and a manufacturing method for said tank.

More specifically, the invention concerns the field of tanks in which the two constituent compartments are intended to contain fluids under a pressure that can reach several bars, for example 20 bars or more, said type of tank being in particular used to store storable and/or cryogenic propellants.

The invention finds in particular an application in the field of launch vehicles and rockets.

### STATE OF THE PRIOR ART

Propellant tanks for launch vehicles have already been the subject of several realisations in the prior art.

In fact, classical cryogenic propellant tanks comprising an external metal wall defining a substantially spherical space, within which liquid oxygen or liquid hydrogen may be introduced, under a pressure not exceeding several bars, are known.

In order to form this type of cryogenic propellant tank, one normally proceeds by assembling, for example by welding, several metal sectors against each other, in order to obtain an external wall of the tank with a substantially spherical shape.

From the prior art are also known tanks for storable propellants, such as monomethylhydrazine or nitrogen peroxide. Unlike cryogenic propellant tanks in which the pressure of the liquids is low due to the presence of turbopumps provided in the vehicle launch stage concerned, storable propellant tanks intended to operate without turbopumps have been designed in such a way as to be able to withstand much higher pressures, which can reach 20 bars or more.

In order to meet the technical constraints, such as the high pressure to withstand and a maximum weight that must not be exceeded in order not to increase the overall weight of the launch vehicle, tanks with an external wall wound in composite material have been developed. It has in fact been observed that the use of such a technique makes it possible to make relatively light tanks and very resistant to high pressures, said advantageous technical characteristics fully complying with those sought.

To manufacture said type of wound tank, one generally carries out a winding using impregnated strands around a winding mandrel, said winding mandrel having a substantially spherical or elliptical shape and complementary to that of the external wall of the tank that one wishes to form. Once this operation has been completed, the external wall of the tank is hardened through polymerisation, then the winding mandrel is dismantled and extracted from the internal spherical space formed by the resulting composite material wall.

Furthermore, other methods for producing two compartment type tanks have also been proposed in the prior art.

In a general manner, said type of tank comprises an external wall defining a space divided into two compartments, within which may be respectively stored a fuel and an oxidant, such as liquid hydrogen and liquid oxygen.

In this type of tank, the main advantage resides in the reduction of the size of the elements enabling the storage of propellants intended to supply the combustion chamber of a launch vehicle stage, particularly compared to the classical solutions of the prior art, in which the two propellants were placed in two separate tanks situated at a distance from each other. Moreover, two compartment tanks normally have a shared partition, dimensioned uniquely to withstand the pressure difference between the two compartments of the tank. Thus, the partition provided between the two compartments is only subjected to a pressure generally less than one bar, and may thus take the form of a simple metal sheet of 1 or 2 millimetres thickness, when the difference in temperature between the propellants does not require an insulating layer to be interposed between the two compartments.

Another type of two compartment tank is described in the document U.S. Pat. No. 5,085,343. The tank described has in fact two sealed metal compartments assembled by screwing one on the other, said two compartments being notably separated by a thermal protection due to the temperature difference between liquid oxygen and liquid nitrogen, stored respectively in one and the other of the two compartments.

However, in all of the two compartment tanks of the prior art which have been described, only tanks with metal compartments have been proposed. This therefore limits the scope of said tanks to that of cryogenic propellants, without extending to that of storable propellants which are nevertheless widely used in present launch vehicles, and need to be maintained under higher pressures. However, the design of the metal assemblies proposed is widely incompatible with the use of the technique of winding impregnated strands around a winding mandrel, which is at present only used in the manufacture of single compartment tanks. As a result, the prior art is not able to provide tanks in composite material comprising two compartments within which may be stored propellants under pressure, said pressure being able to reach for example 20 bars or more.

### OBJECTS OF THE INVENTION

The objects of the invention are therefore to propose a tank for fluids under pressure comprising two compartments as well as its method of manufacture, said tank solving, at least in part, the disadvantages mentioned above relating to the tanks of the prior art.

More precisely, one object of the invention is to provide a tank comprising two compartments within which may be stored fluids under a pressure that may reach several bars, such as storable propellants suitable for fuelling the combustion chamber of a launch vehicle stage.

In order to achieve this, the invention is related to a method for manufacturing a tank for fluids under pressure comprising two compartments. According to the invention, the method for manufacturing comprises the following steps:

assembling a mandrel with a shape substantially complementary to that of an external wall of the tank;

placing a metal wall on the mandrel, said metal wall being of a folded shape and being placed in such a way as to closely fit against a part of said mandrel;

forming the external wall of the tank in composite material, around an assembly comprising the mandrel and the folded metal wall;

polymerising the external wall in composite material of the tank;

dismantling the mandrel;

unfolding the metal wall within the interior of the external wall of the tank, in such a way as to obtain a first compartment within the metal wall, as well as a second compartment between the external wall of the tank in composite material and the metal wall.

Advantageously, the method according to the invention makes it possible to obtain a tank with two compartments each being able to contain fluids under high pressures, such as storable propellants intended to fuel the combustion chamber of a launch vehicle stage.

In fact, the second compartment of the tank is partially demarcated by an external wall in composite material, for which the manufacturing technique by means of a mandrel is entirely suited to forming a wall with high mechanical resistance. Moreover, said technique also used for the manufacture of tanks in composite material with a single compartment is perfectly controlled, and very easy to implement. By way of indicative examples, said mandrel may be designed to allow the formation of the external wall in composite material by winding, contact winding, drape moulding, or any other method leading to the formation of a wall in composite material.

Moreover, the first compartment is defined within the interior of a simple metal wall also participating in part to the demarcation of the second compartment of the tank, said metal wall being situated within the interior of the external wall in composite material. In this way, the fluid present in said first compartment may also be maintained under high pressure, in so far as the metal wall must uniquely withstand the pressure difference between said two compartments, said pressure difference not generally being greater than 1 bar. Moreover, it should be noted that by using this type of method according to the invention, the metal wall and the external wall in composite material may comprise portions in contact, especially when the polymerisation operation of the external wall in composite material leads to a bonding of a portion of the metal wall onto said external wall of the tank. In such a case, at the level of the contact zones between the two walls, the pressure exercised by the fluid contained in said first compartment is mechanically taken up by the assembly formed by the metal wall and the wall in composite material, which naturally allows the high pressure storage of the fluid concerned.

According to a preferred embodiment of the present invention, the application of a thermal protection is carried out by introducing said protection within the interior of the second compartment, by at least one first manhole crossing through the external wall in composite material. In order to achieve the bonding of the thermal protection on the portion of the metal wall separating the first and second compartments of the tank, one may then provide for the presence of means of support within the interior of the first compartment of the tank. The means of support are preferentially introduced within the interior of the first compartment in crossing through the external wall in composite material and the metal wall by at least one second manhole, formed on the portions in contact with the external wall in composite material and the metal wall.

According to another preferred embodiment of the present invention, after the step of placing the metal wall on the mandrel and before forming the external wall of the tank in composite material, one bonds a thermal protection on a portion of the metal wall not in contact with the mandrel, then one applies a layer of release agent on said thermal protection. Thus, after the step of unfolding the metal wall, the assembly formed by the unfolded metal wall partially coated with said thermal protection is taken off the wall in composite material, then turned over and re-bonded onto said external wall of the tank in composite material, in such a way that the thermal protection is located on a portion of the metal wall separating the first and second compartments of the tank.

Preferentially, the operation of turning over and re-bonding the assembly formed by the unfolded metal wall partially coated with the thermal protection is carried out by introducing suitable tools into the second compartment of the tank, in crossing through the wall in composite material by at least one manhole.

One could then provide for the re-bonding of the assembly formed by the metal wall partially coated with the thermal protection to be carried out by introducing a fluid into the first compartment, in order to place the metal wall under pressure during the application of said metal wall against the external wall in composite material.

In a preferred manner, the assembly of the mandrel is carried out on a support axis, on which is also inserted the folded metal wall, during the placing of said metal wall on the mandrel.

Moreover, before placing the metal wall on the mandrel, the metal wall may be folded in such a manner that it is divided into two parts that are substantially identical and in surface contact, one of said two parts closely fitting against the mandrel after the step of placing the metal wall on said mandrel, and being symmetrical to the other of said two parts after the step of unfolding the metal wall.

Advantageously, the step of unfolding the metal wall is carried out through expansion by injecting a fluid within the interior of said metal wall. In a preferred manner, the injection of fluid is carried out by means of injection crossing through the external wall in composite material and the metal wall by at least one second manhole, formed on the portions lying flat against each other of the external wall in composite material and the metal wall. It should be noted that it is also possible to provide for the injection of fluid to be assisted by at least one piston that ensures the unfolding of the metal wall in a symmetrical manner, each piston being introduced into the second compartment of the tank by means of at least one first manhole crossing through said external wall in composite material.

Moreover, another object of the invention is to provide a tank for fluids under pressure comprising two compartments, of which a first of said compartments is situated within the interior of a metal wall. According to the invention, the tank comprises an external wall in composite material within which is placed said metal wall partially in contact with said external wall of the tank, a second compartment of said tank being located between the external wall in composite material of the tank and said metal wall.

Advantageously, with such a set up, the tank proposed according to the invention makes it possible to store storable and/or cryogenic propellants, under a pressure that could easily reach several bars.

Other advantages and characteristics of the invention will become clearer from the detailed, non-limitative description that follows.

### BRIEF DESCRIPTION OF THE DRAWINGS

This description will be made in relation to the appended drawings, amongst which:

FIG. 1 represents a schematic cross section of a tank according to a preferred embodiment of the present invention;

FIGS. 2a to 2e represent schematic views explaining the different steps of a method for manufacturing the tank represented in FIG. 1, according to a preferred embodiment of the present invention;

FIGS. 3a to 3e represent schematic views explaining the different steps of a method for manufacturing the tank represented in FIG. 1, according to another preferred embodiment of the present invention.

### DETAILED DESCRIPTION OF PREFERRED EMBODIMENTS

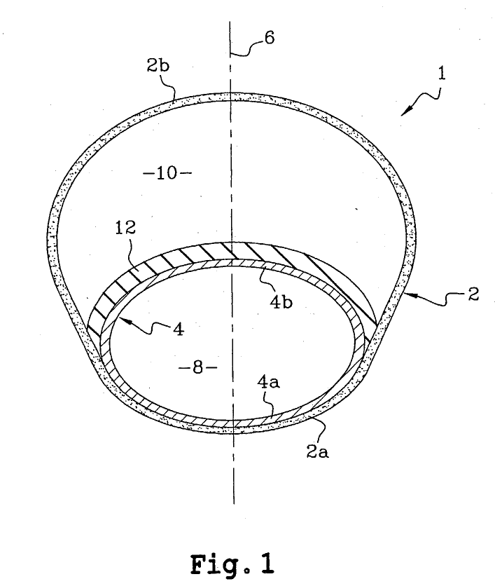

FIG. 1 shows a tank 1 for fluids under pressure, according to a preferred embodiment of the present invention.

Preferably, the fluids under pressure used are storable and/or cryogenic propellants, intended to fuel a combustion chamber of a launch vehicle stage (not shown). The tank 1 is designed to withstand pressures of around 20 bars or more, said value corresponding substantially to a pressure required for storable propellants fuelling a combustion chamber, without going through turbopumps.

The tank 1 comprises an external wall 2 in composite material, of substantially spherical or elliptical shape and formed preferably by means of impregnated strands wound, in a classical manner, around a winding mandrel. Obviously, said external wall 2 in composite material could also be formed by contact winding, or even by drape moulding, without going beyond the scope of the invention.

A metal wall 4, of smaller dimensions than the external wall 2 in composite material, is located within the interior of said external wall. The metal wall 4, preferably made out of aluminium, is of a substantially flattened spherical or elliptical shape, and coaxial with axis 6 with the external wall 2 of the tank 1.

As can be seen in FIG. 1, the metal wall 4 is partially in contact with the external wall 2 in composite material. In order to establish this contact, the external wall 2 and the metal wall 4 have respectively portions 2a and 4a of substantially complementary shapes, said portions 2a and 4a being in surface contact and bonded to each other.

It should be noted that in a preferential manner, the portion of contact 4a of the metal wall 4 corresponds to a half of said wall, having a slightly flattened demi-sphere shape. Moreover, in order for the portion 2a of the external wall 2 in composite material to completely fit up against the portion 4a of the metal wall 4, the portion 2a has a bend radius slightly less than an average bend radius of the external wall 2 of substantially spherical or elliptical shape.

The tank 1 comprises two compartments 8 and 10, intended to contain fluids under pressure, a first compartment 8 being located within the interior of the metal wall 4. The first compartment 8 is therefore a space with a substantially flattened spherical shape.

The second compartment 10 of the tank 1 is located between the external wall 2 and the metal wall 4. In other words, the second compartment 10 is demarcated on the one hand by a portion 2b of the external wall 2 not in contact with the metal wall 4, and on the other hand by a portion 4b of the metal wall not in contact with the external wall 2 of the tank 1.

It should be noted that in this configuration, the portion 4b of the metal wall 4, substantially identical and symmetrical to the portion 4a of said same wall, constitutes a separation between the two compartments 8 and 10 of the tank 1.

As a result, the second compartment 10 has a substantially spherical or elliptical shape, partially cut off by another slightly flattened coaxial sphere of smaller diameter.

In the preferred embodiment described, the portion 4b of the metal wall 4 separating the first and second compartments 8 and 10 is provided externally, in other words on the side of the compartment 10, with a thermal protection 12. The thermal protection 12 is bonded on the whole surface of the portion 4b of the metal wall 4, and formed preferably in a honeycomb. It should be noted that the thermal protection 12 is essentially provided to deal with the temperature difference that may exist between the two fluids under pressure within the two compartments 8 and 10 of the tank 1, particularly in the case where the two propellants used are liquid hydrogen and liquid oxygen.

The invention also concerns a method for manufacturing a tank for fluids under pressure comprising two compartments, such as that described above and represented in FIG. 1.

In the preferred embodiments that will be described below, it is pointed out that the external wall 2 in composite material is formed by classical winding. Naturally, said wall 2 could also be formed by any other known method using a mandrel as support for forming said wall, such as contact winding or drape moulding, without going beyond the scope of the invention.

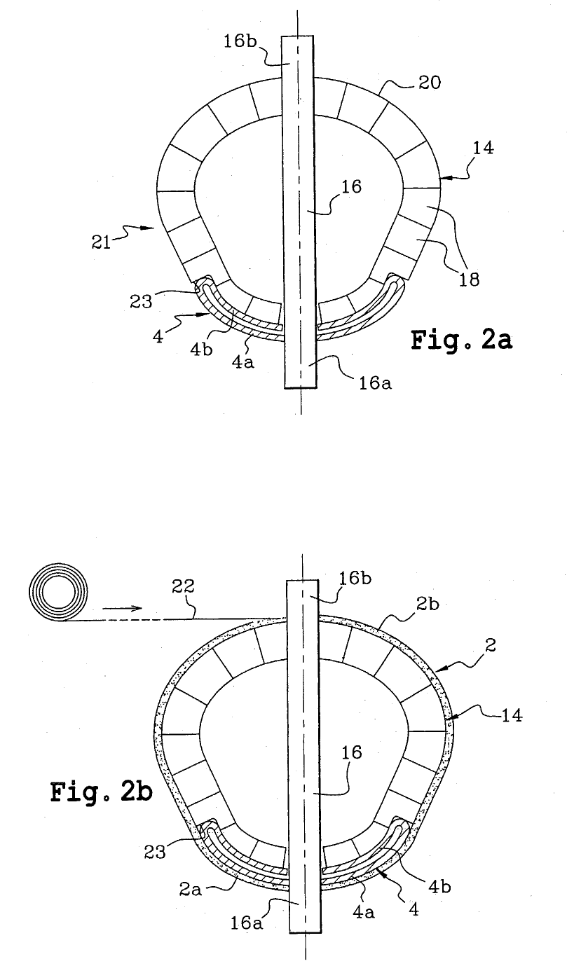

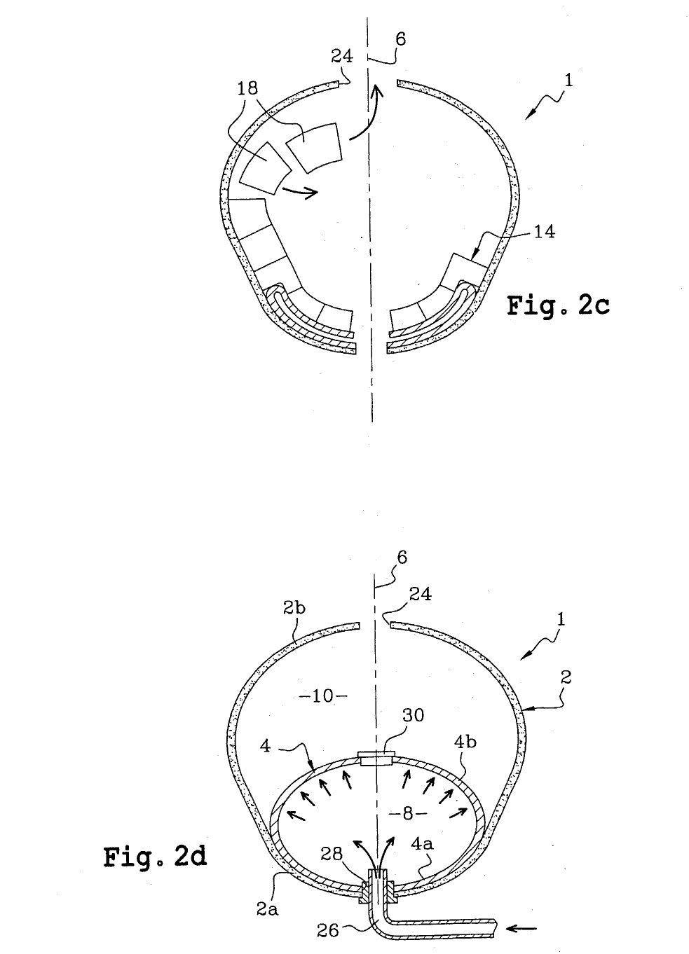

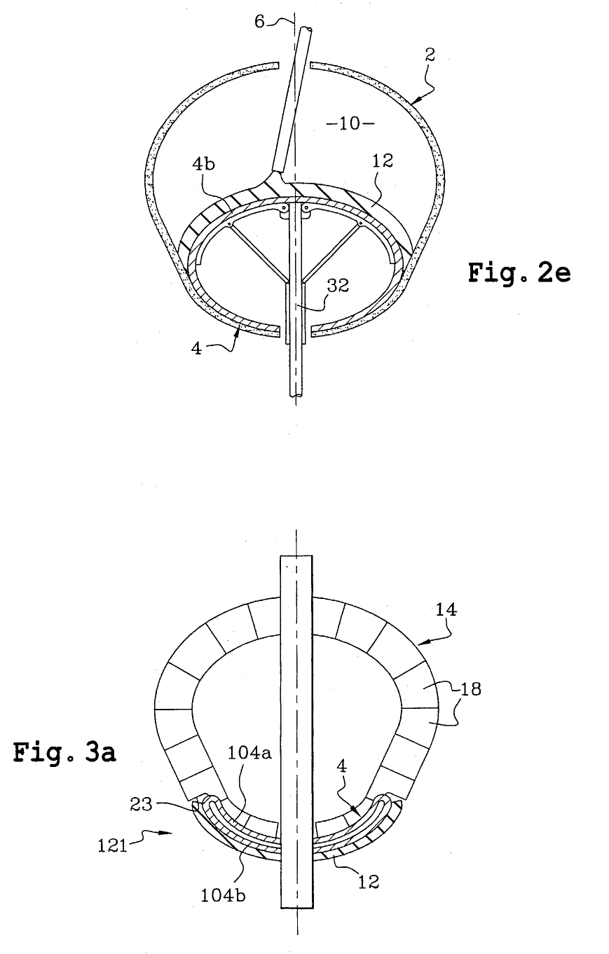

A preferred embodiment of the method for manufacturing the tank 1 is now going to be described, in referring to FIGS. 2a to 2e.

Referring to FIG. 2a, the first step of the method consists in assembling a winding mandrel 14 on a support axis 16 oriented vertically. The winding mandrel 14 comprises a plurality of rigid elements 18 which, when they are assembled together, allow the mandrel to have an external surface 20 of a shape substantially complementary to the shape of the external wall 2 to be formed.

Then, still referring to FIG. 2a, one places the metal wall 4 in a folded shape on the winding mandrel 14. The placing of the metal wall 4 is carried out by inserting in the support axis 16, at the level of a lower end 16a of said axis 16, up to the point where said metal wall 4 closely fits against a part of the external surface 20 of the winding mandrel 14.

It should be noted that before the metal wall 4 is placed on the winding mandrel 14, said metal wall 4 is folded in such a manner that its two constituent substantially identical portions 4a and 4b are in surface contact over the whole of their respective surfaces. The putting in place is then carried out in such a manner that the portion 4b with a flattened demi-spherical shape, intended subsequently to separate the first and second compartments 8 and 10 of the tank 1, closely fits against the winding mandrel 14. Thus, when the placing of the metal wall 4 is finished, one obtains an assembly 21 comprising the winding mandrel 14 and the folded metal wall 4. The assembly 21 then has a complementary shape to that of the external wall 2 to be formed. It should be noted that, as can be seen on FIG. 2a, certain rigid elements 18 constituting the winding mandrel 14 and intended to be closely fitted to the portion 4b of the metal wall 4 may be designed in order to form a hollow 23. Said hollow 23 thus allows the winding mandrel 14 to receive the metal wall 4, in such a way that the assembly 21 has a continuous external surface constituted by the external surface 21 of the mandrel 14 and the portion 4a of the wall 4, said composed surface then not having any ruptures due to the over-thickness caused by the presence of the metal wall 4.

Then, it may be conceivable to carry out an operation consisting in the application of a single-layer or multi-layer element all around the winding mandrel 14 and the portion 4a of the metal wall 4, in order to ensure the leaktightness of the tank 1. By way of example, said element (not shown) may be plastic or metallic.

The following step, illustrated by FIG. 2b, concerns the formation of the external wall 2 of the tank 1 in composite material, carried out in a classical manner by winding impregnated strands 22 around the assembly 21. It should be noted that said assembly 21 may also comprise the element ensuring the leaktightness of the tank, when it has been assembled during the preceding optional operation.

Once the winding of the strands 22 is finished, one moves onto the polymerisation operation of the external wall 2 in composite material, in order to provoke the hardening of said external wall. The polymerisation operation may then consist in a simple heating, also leading to the bonding of the portion 4a of the metal wall 4 onto the portion 2a of the external wall 2 of the tank 1.

In referring to FIG. 2c, one then carries out the dismantling of the winding mandrel 14, by extracting the constituent elements 18 of said mandrel 14, outside of the sealed space demarcated by the external wall 2 of the tank 1. In order to achieve this, each constituent element 18 of the winding mandrel 14 is first dismantled from the rest of the mandrel 14, then extracted from the sealed space by means of a first manhole 24.

In the preferred embodiment described, a single first manhole 24 is provided in the external wall 2 of the tank 1, at the level where was situated an upper end 16b of the support axis 16 of the winding mandrel 14, during the operation of winding the impregnated strands 22 intended to form said external wall 2. Obviously, it is also possible to provide a higher number of first manholes 24, without going beyond the scope of the invention.

Then, one carries out the unfolding of the metal wall 4 within the interior of the external wall 2 of the tank 1. More precisely, it is the portion 4b of the metal wall 4 that is unfolded, in such a way that the first compartment 8 is defined within the interior of the initially folded metal wall 4, and in such a way that the second compartment 10 of the tank 1 is defined between the portion 2b of the external wall 2, and the portion 4b forming the partition of the metal wall 4.

Preferably, the step of unfolding the metal wall 4 is carried out through expansion, by injecting a fluid within the interior of the metal wall 4.

In referring to FIG. 2d, in order to inject the fluid such as gas under pressure, means of injection comprising an output pipe 26 are connected to the tank 1.

The output pipe 26 is installed on the tank 1, in such a way as to cross through the portions lying flat against each other and in contact 2a and 4a and the external wall 2 and the metal wall 4, by a second manhole 28.

In the preferred embodiment described, a single second manhole 28 is provided in the external wall 2 and the metal wall 4 of the tank 1, at the level where was situated the lower end 16a of the support axis 16 of the winding mandrel 14, during the operation of winding the impregnated strands 22 intended to form the external wall 2. Obviously, it is also possible to provide a higher number of second manholes 28, without going beyond the scope of the invention.

Moreover, it should be pointed out that the step of inserting the metal wall 4 on the support axis 16 requires the formation of an orifice on each of the portions 4a and 4b of the metal wall 4. Thus, whereas the orifice provided on the portion 4a is used to form the second manhole 28, the orifice present on the portion 4b may be sealed by means of a plug 30, before the unfolding through expansion of the metal wall 4 of the tank 1.

Moreover, one can also provide that the injection of gas under pressure from the pipe 26 may be helped by at least one piston (not shown), ensuring the symmetrical unfolding of the metal wall 4. By way of example, the piston(s) used may then be introduced into the second compartment 10 of the tank 1, by the first manhole 24 provided on the external wall 2 of the tank 1.

In the embodiment described, following the unfolding of the metal wall 4, one also carries out the application of a thermal protection 12 on the portion 4b of the metal wall 4, separating the first compartment 8 and the second compartment 10 of the tank 1.

The thermal protection 12 is then inserted into the second compartment 10 by the first manhole 24, then bonded onto the portion 4b forming the partition of the metal wall 4.

As illustrated in FIG. 2e, it should be noted that to facilitate the operation of bonding the thermal protection 12 on the portion 4b of the metal wall 4, one can if necessary provide for the presence of umbrella type means of support 32 within the interior of the first compartment 8. In order to do this, the umbrella 32 is first of all introduced into the first compartment 8 by the second manhole 28, then unfolded within the interior of said compartment in such a way as to completely fit up against the portion 4b of the metal wall 4. Thus, the portion 4b is put under pressure and is not deformed under the stress exercised by the thermal protection 12, during the operation of bonding of said protection.

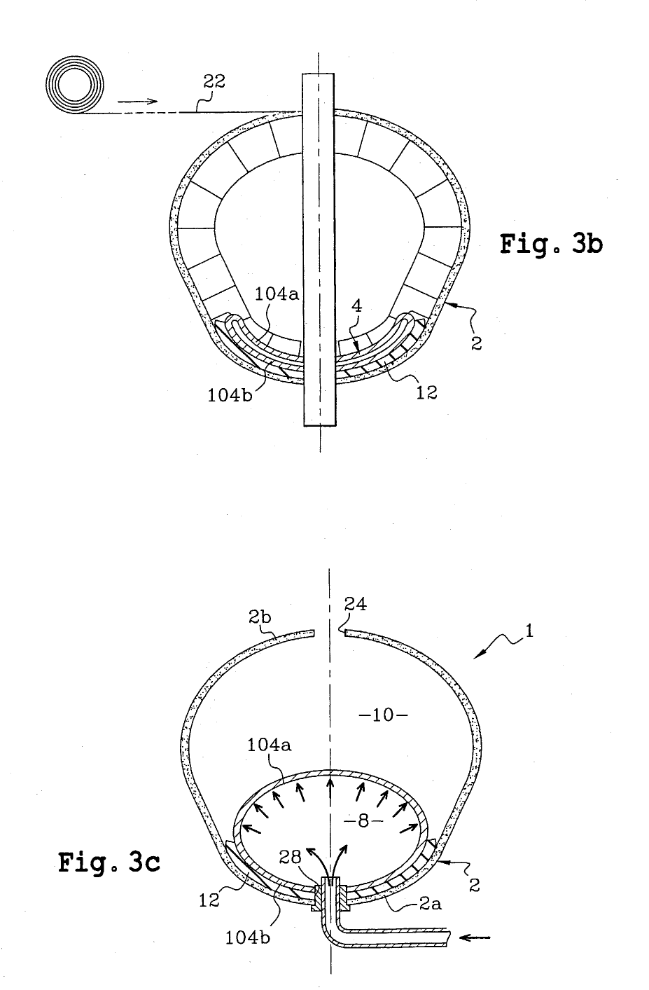

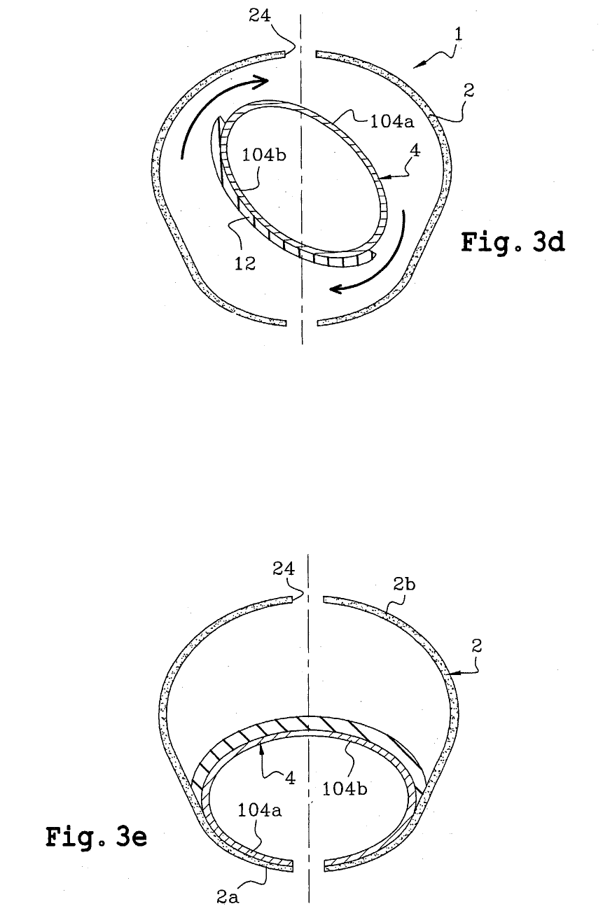

According to another preferred embodiment of the method of manufacture according to the invention, the step of placing the metal wall 4 on the winding mandrel 14, represented in FIG. 2a, is followed by an operation of bonding the thermal protection 12 onto a portion 104b of the metal wall 4 not in contact with the winding mandrel 14 (FIG. 3a). It should be noted that in this preferred embodiment, unlike the previously described preferred embodiment, the portion 104b of the metal wall 4 intended to separate the first and second compartments 8 and 10 is not the portion of metal wall 4 initially in contact with the winding mandrel 14. In fact, it is a portion 104a closely fitting against the portion 104b that is provided to be in contact with the winding mandrel 14 following the putting in place of the metal wall 4, said portion 104a being subsequently intended to be in contact with the portion 2a of the external wall 2. However, it should be pointed out that the portions 104b and 104a of the metal wall 4 are respectively similar to the portions 4a and 4b of the metal wall 4 described in the preferred embodiment presented above.

The thermal protection 12 is then arranged to substantially fit closely against the whole of the surface of the portion 104b of the metal wall 4. Following this, a layer of release agent (not shown) is applied on the face of the thermal protection 12 not in contact with the portion 104b of the metal wall 4, in order to create an assembly 121 formed by the winding mandrel 14, the metal wall 4, the thermal protection 12, and the applied layer of release agent. The assembly 121 is then of a shape that is complementary to that of the external wall 2 to be formed. It should be noted that, as in the previous embodiment, it is possible to provide a hollow 23 in the winding mandrel 14, in which are able to stand the metal wall 4 and the thermal protection 12, so that the assembly 121 has a composed external surface without any ruptures.

When the operations that have just been described are finished, one forms the external wall 2 of the tank 1, by winding impregnated strands 22 around the assembly 121, as represented in FIG. 3b. The portion 104b of the metal wall 4 is then set flat against the portion 2a of the external wall 2, but separated from it by means of the thermal protection 12 coated with a layer of release agent.

The steps of polymerisation of the external wall 2 of the tank 1, dismantling the winding mandrel 14 and unfolding the metal wall 4 are carried out in the same manner as in the previously described embodiment. The tank 1 obtained, represented in FIG. 3c, comprises a first manhole 24 on the portion 2b of the external wall 2, said manhole 24 being arranged substantially in the same place as in the previously described preferred embodiment. In the same way, the tank 1 comprises a second manhole 28 crossing through the portion 2a of the external wall 2, as well as the portion 104b of metal wall 4. The second manhole 28 also arranged in the same place as in the previously described preferred embodiment, is moreover formed in the thermal protection 12 provided between the two portions 2a and 104b cited above. This allows the means of injection of fluid (not shown), used to achieve the unfolding of the metal wall 4, to be able to have an access to the interior of said metal wall 4.

As mentioned above, after the dismantling of the winding mandrel 14, one has a tank 1 comprising the first compartment 8 and the second compartment 10, demarcated by the external wall 2 and the metal wall 4 laid flat one against the other, and separated by the thermal protection 12.

In order to place the thermal protection 12 between the first compartment 8 and the second compartment 10, the metal wall 4 partially coated with the thermal protection 12 is firstly taken off the portion 2a of the external wall 2 to which the thermal protection 12 adheres. Then, as illustrated in FIGS. 3d and 3e, the metal wall 4 partially coated with the thermal protection 12 is turned round and then re-bonded onto the external wall 2. These various operations are carried out in such a way that the portion 104b bearing the thermal protection 12, initially lying flat against the external wall 2, forms a partition between the first compartment 8 and the second compartment 10. In other words, the portion 104b takes the place of the portion 104a, and vice versa. Thus, when these various operations are finished, the portion 104a of the metal wall 4 is bonded onto the portion 2a of the external wall 2 of the tank 1.

It should be noted by way of example that the steps of turning over and re-bonding may be carried out by introducing suitable tools (not shown) within the interior of the external wall 2, by means of the first manhole 24.

Moreover, it is pointed out that the re-bonding of the portion 104a of the metal wall 4 onto the portion 2a of the external wall 2 is carried out by introducing a fluid into the first compartment 8 of the tank 1, in order to place the metal wall 4 under pressure during this re-bonding operation.

Finally, according to yet alternative of this preferred embodiment, it should be noted that the metal wall 4 partially coated with the thermal protection 12 may undergo the operation of turning over before the operation of unfolding the metal wall 4.

Obviously, various modifications may be made by those skilled in the art to the tank 1 and to the methods of manufacture of a tank such as that which has just been described, uniquely by way of example and in nowise limitative.

1. Method for manufacturing a tank for fluids under pressure comprising two compartments, characterised in that it comprises the following steps:
assembling a mandrel with a shape substantially complementary to that of an external wall of the tank;
placing a metal wall on the mandrel, said metal wall being of a folded shape and being placed in such a way as to closely fit against a part of said mandrel;
forming the external wall of the tank in composite material, around an assembly comprising the mandrel and the folded metal wall;
polymerising the external wall in composite material of the tank;
dismantling the mandrel;
unfolding the metal wall within the interior of the external wall of the tank, in such a way as to obtain a first compartment within the metal wall, and a second compartment between the external wall of the tank in composite material and the metal wall.

2. Method for manufacturing a tank according to claim 1, characterised in that the polymerisation operation of the external wall in composite material leads to the bonding of the metal wall on the external wall in composite material.

3. Method for manufacturing a tank according to claim 1, characterised in that after the step of unfolding the metal wall, one applies a thermal protection on a portion of the metal wall separating the first and the second compartments of the tank.

4. Method for manufacturing a tank according to claim 3, characterised in that the application of the thermal protection is carried out by introducing said protection within the interior of the second compartment, by at least one first manhole crossing through said external wall in composite material.

5. Method for manufacturing a tank according to claim 4, characterised in that the application of the thermal protection is carried out by bonding of said protection on the portion of the metal wall separating the first and second compartments of the tank, in the presence of means of support situated within the interior of the first compartment of the tank.

6. Method for manufacturing a tank according to claim 5, characterised in that one introduces the means of support within the interior of the first compartment in crossing through the external wall in composite material and the metal wall by at least one second manhole, formed on the portions in contact with the external wall in composite material and the metal wall.

7. Method for manufacturing a tank according to claim 1, characterised in that after the step of placing the metal wall on the mandrel and before forming the external wall of the tank in composite material, one bonds a thermal protection on a portion of the metal wall not in contact with the mandrel, then one applies a second layer of release agent on said thermal protection.

8. Method for manufacturing a tank according to claim 7, characterised in that after the step of unfolding the metal wall, the assembly formed by said unfolded metal wall partially coated with the thermal protection is taken off the external wall in composite material, then turned over and re-bonded onto said external wall of the tank in composite material, in such a way that the thermal protection is located on a portion of the metal wall separating the first and second compartments of the tank.

9. Method for manufacturing a tank according to claim 8, characterised in that the operation of turning over and re-bonding the assembly formed by said unfolded metal wall partially coated with the thermal protection is carried out by introducing suitable tools into the second compartment of the tank, in crossing through the wall in composite material by at least one manhole.

10. Method for manufacturing a tank according to claim 9, characterised in that the re-bonding of the assembly formed by said metal wall partially coated with the thermal protection is carried out by introducing a fluid into the first compartment, in order to place the metal wall under pressure during the application of said metal wall against the external wall in composite material.

11. Method for manufacturing a tank according to claim 1, characterised in that the assembly of the mandrel is carried out on a support axis, on which is also inserted the folded metal wall, during the placing of said metal wall on the mandrel.

12. Method for manufacturing a tank according to claim 1, characterised in that before the placing of the metal wall on the mandrel, the metal wall is folded in such a manner that it is divided into two parts substantially identical and in surface contact, one of said two parts closely fitting against the mandrel after the step of placing the metal wall on said mandrel, and being symmetrical to the other of said two parts after the step of unfolding the metal wall.

13. Method for manufacturing a tank according to claim 1, characterised in that the step of dismantling the mandrel includes a step of extracting the constituent elements of said mandrel outside of the second compartment of the tank, by at least one manhole crossing through said external wall in composite material.

14. Method for manufacturing a tank according to claim 1, characterised in that the step of unfolding the metal wall is carried out through expansion by injecting a fluid into said metal wall.

15. Method for manufacturing a tank according to claim 14, characterised in that the injection of fluid is carried out with the aid of injection means crossing through the external wall in composite material and the metal wall by at least one second manhole, formed on the portions lying flat against each other of the external wall in composite material and the metal wall.

16. Method for manufacturing a tank according to claim 15, characterised in that the injection of fluid is helped by at least one piston that ensures the unfolding of the metal wall in a symmetrical manner, each piston being introduced into the second compartment of the tank by at least one first manhole crossing through said external wall in composite material.

17. Tank for fluids under pressure comprising two compartments of which a first of said compartments is situated within the interior of a metal wall, characterised in that the tank comprises an external wall in composite material within which is placed said metal wall partially in contact with said external wall of the tank, a second compartment of said tank being located between the external wall in composite material of the tank and said metal wall.

18. Tank according to claim 17, characterised in that the metal wall comprises two symmetrical parts, one of said two portions being in contact with the external wall in composite material of the tank, and the other of said two portions separating the first and the second compartments of the tank.

19. Tank according to claim 18, characterised in that the portion of the metal wall separating the first and the second compartments of the tank is coated with a thermal protection.

20. Tank according to claim 17, characterised in that the external wall in composite material and the metal wall are substantially spherical and coaxial.

21. Tank according to claim 17, characterised in that the two compartments) are suitable for containing storable and/or cryogenic propellants.
